(19) United States
(12) Patent Application Publication
(10) Pub. No.: US 2018/0244207 A1
(43) Pub. Date: Aug. 30, 2018

(54) HANDHELD AND VEHICLE MOUNTED BAG HOLDERS

(71) Applicant: Peter Marvin Weldon, Bartow, FL (US)

(72) Inventor: Peter Marvin Weldon, Bartow, FL (US)

(21) Appl. No.: 15/442,883

(22) Filed: Feb. 27, 2017

(51) Int. Cl. B60R 7/08; B60N 3/08

(52) U.S. Cl. CPC B60R 7/08; B65F 1/1415; B60N 3/08

(57) ABSTRACT

Described are handheld and vehicle mounted bag holders. The bag holders include a curved frame member defining a portion of a circle's curvature. The curved frame member is covered by an elastomeric pad such as foam. The handheld bag holder includes a handle attached to the frame member. The vehicle mounted bag holder includes a rotating bracket and a mounting element. The vehicle mounted bag holder can be mounted on the frame of a vehicle such as an all terrain vehicle via the mounting element.

### FIELD

Some implementations relate generally to an apparatus for holding a bag, and, in particular, to handheld and vehicle mounted bag holders.

### BACKGROUND

Flexible plastic bags are commonly used for packaging or holding cut grass, leaves, debris, trash, refuse and other unwanted materials. Cleaning tasks can be facilitated by maintaining the plastic bags with a mouth of the bag (e.g., opening of the bag) in an open or widely open position, by protecting an area of the bags adjacent to the opening from puncturing or tearing, and by facilitating easy removal of a filled bag and installation of an empty bag during and after the collection process.

Some conventional technique for handling bags may not maintain the mouth of the bag in an open position, or may involve the use of trash cans or bins to hold the bags. The trash cans or bins may add additional weight and may be cumbersome for some tasks.

It may be desirable to provide a device for maintaining a plastic bag with the mouth of the bag in an open position for handheld and/or vehicle mounted use, protecting an area of the bag adjacent to the opening from tearing, and facilitating easy removal of a full bag and installation of an empty bag. Some implementations were conceived in light of the above-mentioned needs, limitations or problems, among other things.

### SUMMARY

Some implementations can include a bag holder. The bag holder can include a frame member having a first end and a second end and a curved surface that substantially conforms to a circle's curvature, or at least a portion or a segment of the circle's curvature. The bag holder can also include a rotating bracket having a first portion and a second portion, and a mounting element configured to be attached to a vehicle frame.

The first portion of the rotating bracket can be attached to the mounting element and the second portion of the rotating bracket can be attached to the frame member. The rotating bracket can be configured to be rotated between an operational position and a stowed position. The rotating bracket can be configured to be locked when in the operational position by engaging a protrusion on the first portion of the rotating bracket with an opening on the second portion of the rotating bracket. The rotating bracket can be placed in the locked operational position by moving the second portion of the rotating bracket to an upward position relative to the second portion of the rotating bracket and then moving the opening on the second portion to be in alignment with the protrusion of the first portion of the rotating bracket and lowering the second portion of the rotating bracket to cause the opening to engage the protrusion.

The bag holder can also include an elastomeric pad disposed on the frame member. The elastomeric pad can be formed from elastomeric foam. The bag holder can also include a first elastomeric end cap disposed on the first end and a second elastomeric end cap disposed on the second end. The curved surface can include more than 180 degrees of the circle's curvature.

The mounting element is configured to be secured to a generally round vehicle frame element. The mounting element can be configured to be secured to a generally rectangular vehicle frame element.

Some implementations can include a bag holder. The bag holder can include a frame member having a first end and a second end and a curved surface that substantially conforms to a circle's curvature, or at least a portion or a segment of the circle's curvature. The bag holder can also include a rotating bracket having a first portion and a second portion, and a mounting element configured to be attached to a vehicle frame.

The first portion of the rotating bracket can be attached to the mounting element and the second portion of the rotating bracket is attached to the frame member. The rotating bracket can be configured to be rotated between an operational position and a stowed position. The rotating bracket can be configured to be locked when in the operational position by engaging a protrusion on the first portion of the rotating bracket with an opening on the second portion of the rotating bracket. The rotating bracket can be placed in the locked operational position by moving the second portion of the rotating bracket to an upward position relative to the second portion of the rotating bracket, aligning a first hole through the first portion of the rotating bracket with a second hole through the second portion of the rotating bracket, and then placing a pin through the first hole and the second hole.

The bag holder can also include an elastomeric pad disposed on the frame member. The elastomeric pad can be formed from elastomeric foam. The bag holder can include a first elastomeric end cap disposed on the first end and a second elastomeric end cap disposed on the second end. The curved surface can include more than 180 degrees of the circle's curvature.

The mounting element can be configured to be secured to a generally round vehicle frame element. The mounting element can be configured to be secured to a generally rectangular vehicle frame element.

Some implementations can include a handheld bag holder. The handheld bag holder can include a frame member having a first end, a second end, and a curved surface that substantially conforms to a circle's curvature, or at least a portion or a segment of the circle's curvature. The bag holder can also include a handle attached to the frame member.

The bag holder can also include an elastomeric pad disposed on the frame member. The elastomeric pad can be formed from elastomeric foam. The bag holder can also include a first elastomeric end cap disposed on the first end and a second elastomeric end cap disposed on the second end. The curved surface can include more than 180 degrees of the circle's curvature. The handle can include a generally rectangular handle.

### BRIEF DESCRIPTION OF THE DRAWINGS

FIG. 1 is a diagram showing a left, front perspective view of an example vehicle mounted bag holder with an elastomeric pad in accordance with some implementations.

FIG. 2 is a diagram showing a left, front perspective view of an example vehicle mounted bag holder with the elastomeric pad removed in accordance with some implementations.

FIG. 3 is a diagram showing a left elevation view of an example vehicle mounted bag holder with elastomeric pad in accordance with some implementations.

FIG. 4 is a diagram showing a bottom elevation view of an example vehicle mounted bag holder with elastomeric pad in accordance with some implementations.

FIG. 5 is a diagram showing a right elevation view of an example vehicle mounted bag holder with elastomeric pad in accordance with some implementations.

FIG. 6 is a diagram showing a top elevation view of an example vehicle mounted bag holder with elastomeric pad in accordance with some implementations.

FIG. 7 is a diagram showing a rear elevation view of an example vehicle mounted bag holder with elastomeric pad in accordance with some implementations.

FIG. 8 is a diagram showing detail of a mounting and swivel mechanism of an example vehicle mounted bag holder with elastomeric pad in accordance with some implementations.

FIG. 9 is a diagram showing a left elevation view of rotation of an example vehicle mounted bag holder from an operational position to a stowed position in accordance with some implementations.

FIG. 10 is a diagram showing a left elevation view of an example vehicle mounted bag holder rotated to a stowed position in accordance with some implementations.

FIG. 11 is a diagram showing a rear elevation view of an example vehicle mounted bag holder with elastomeric pad in accordance with some implementations.

FIG. 12 is a diagram showing detail of a mounting bracket and swivel mechanism of an example vehicle mounted bag holder with elastomeric pad in accordance with some implementations.

FIG. 13 is a diagram showing a left elevation view of rotation of an example vehicle mounted bag holder from an operational position to a stowed position in accordance with some implementations.

FIG. 14 is a diagram showing a left elevation view of an example vehicle mounted bag holder rotated to a stowed position in accordance with some implementations.

FIG. 15 is a diagram showing a left perspective view of an example handheld bag holder with elastomeric pad in accordance with some implementations.

FIG. 16 is a diagram showing a left perspective view of an example handheld bag holder with elastomeric pad removed in accordance with some implementations.

### DETAILED DESCRIPTION

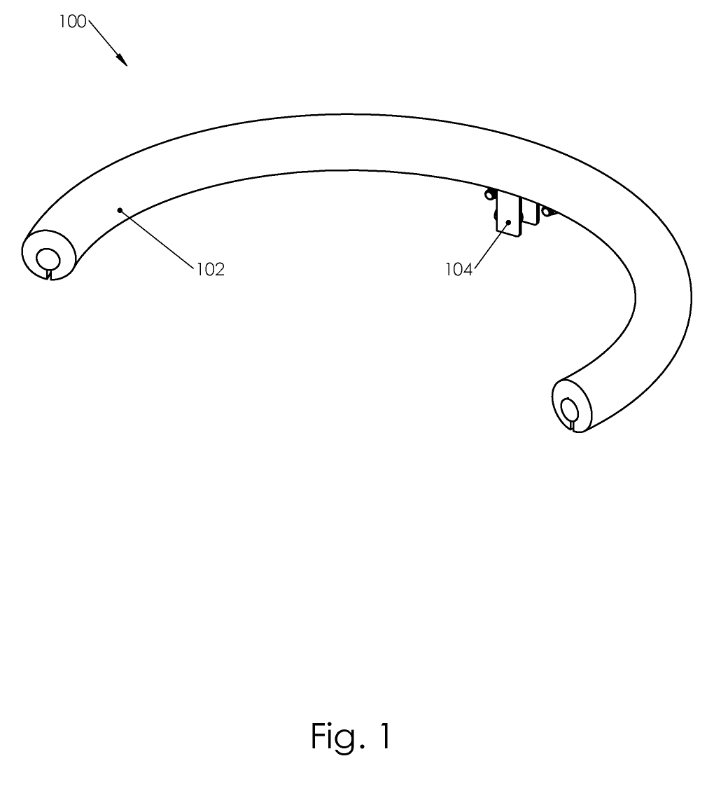

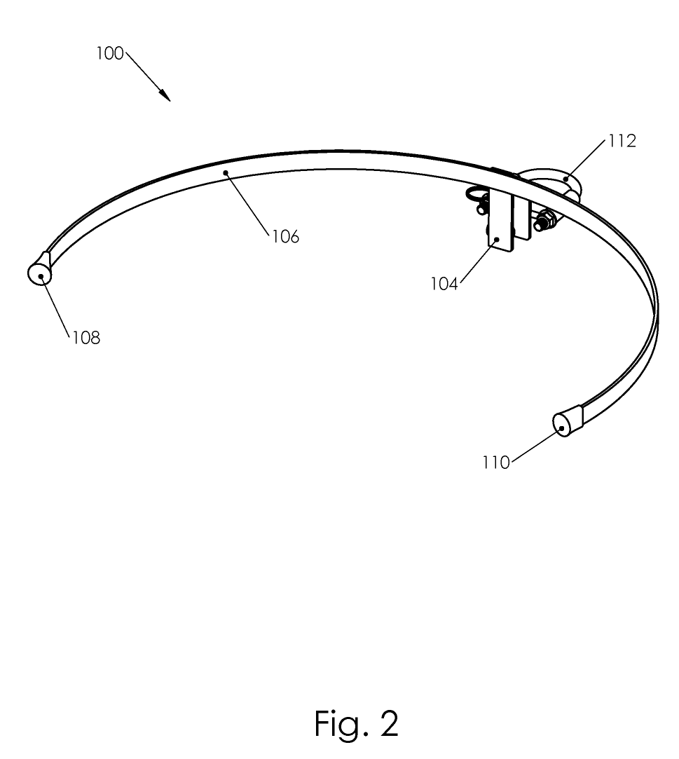

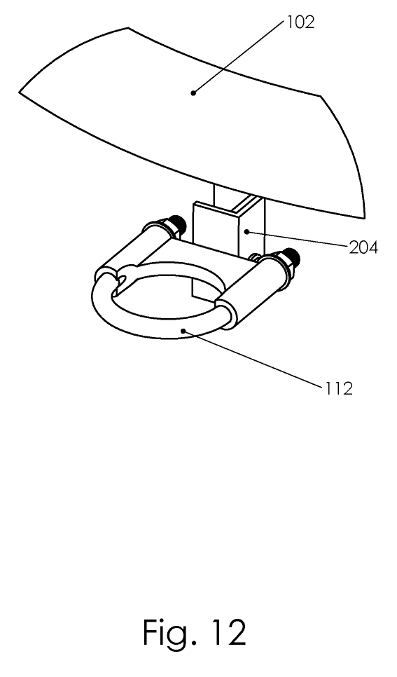

FIGS. 1-14 show diagram of example vehicle mounted bag holding devices (e.g., 100). As shown in FIG. 1, an example vehicle mounted bag holder 100 includes an elastomeric pad 102 and a rotating bracket 104. FIG. 2 shows the vehicle mounted bag holder 100 with the elastomeric pad 102 removed to reveal a frame member 106, a first elastomeric end cap 108, a second elastomeric end cap 110, and a mounting element 112. The frame member 106 can be formed from steel, aluminum, injection molded plastic or other suitable material. The frame member 106 can include a metal (e.g., steel) piece that is 3/16″ thick, ¾″ wide and about 36 to 42 inches long. The frame member 106 can also provide spring tension to help hold a bag in place. For example, the frame member 106 may have an end to end distance of about 27 inches, which, when taken in conjunction with the length of about 36-42 inches may provide a slightly larger opening than may be able to accommodate the bag without the frame member 106 being placed under some tension. The frame member 106 may be placed under some external pressure (e.g., squeezed together slightly by force of the bag diameter) to effectively make the portion of a circle defined by the frame member smaller so as to accommodate the bag opening size. Then, once the bag is mounted on the frame member and elastomeric pad, the tension of the frame member 106 in an outward expansion direction can act to help keep the bag in place on the bag holder.

The elastomeric pad 102 can include an elastomeric pad (e.g., elastomeric foam pad similar to that used to insulate pipes) and can be removable or fixed in place. The elastomeric pad 102 can include a passageway extending the length of the element configured to accommodate insertion of the frame member 106 via a slit along the elastomeric pad 102.

For example, an elastomeric pad used in an exemplary prototype bag holder according to the present disclosure was a length of a widely available elastomeric foam material sold for use in insulating a length of water pipe to impair the loss of heat from a pipe conducting hot water. The pipe insulating material has a passageway extending longitudinally along the entire length of the insulating material and is slit along the entire length of the insulating material to facilitate wrapping the insulating material around a water pipe. The edges of the slit are commonly provided with adhesive strips to fasten the edges of the slit together to retain the insulating material in place around the water pipe. The elastomeric foam material used with the exemplary prototype of the second embodiment of the present invention had a passageway with a diameter of about ½ to about ⅜ inch with the wall of elastomeric foam having a thickness of about ½ inch, and a length of about 36 inches to 42 inches which is of similar length as the length of the frame member 106. There are prior art bag holder devices that require one or more clips to be used to retain a plastic bag folded over a support member of the device, which requires effort by a person to install and remove the clips, and hopefully not misplace or damage the clips. The elastomeric pad of the present disclosure (e.g., 102) preferably has a surface that is not smooth for engaging a plastic bag folded around the elastomeric pad and frame member, but rather is uneven and rough enough to cause friction between the pad and the plastic bag to aid in maintaining the plastic bag in a desired operative position with regards to the bag holder to retain the plastic bag in substantially static contact with the bag holder with the bag open. An elastomeric foam pad without a smooth outer engagement surface meets these requirements at a reasonable cost. It is understood that if desired the elastomeric pad does not have to extend continuously along the entire length of the frame member and does not have to be folded around the frame member so long as the elastomeric pad, or pads, engage a plastic bag that is folded over the frame member.

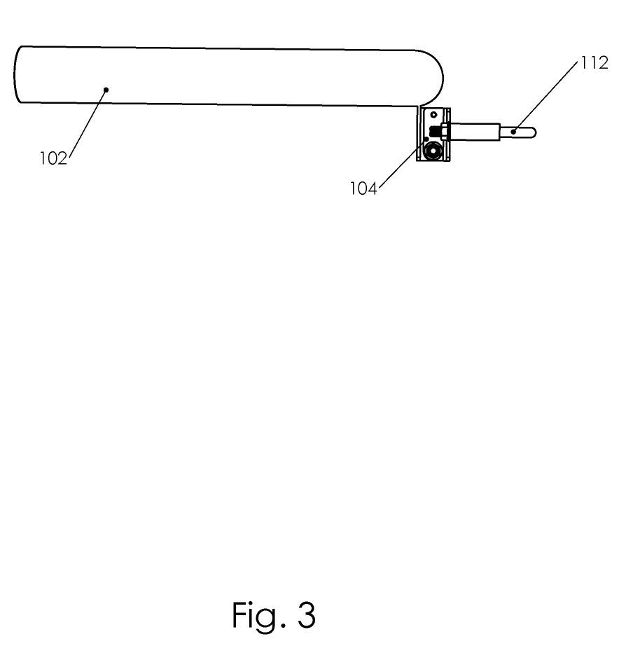

FIG. 3 shows a left side elevation view of the vehicle mounted bag holder in which the elastomeric pad 102, the rotating bracket 104 and the mounting element 112 are visible.

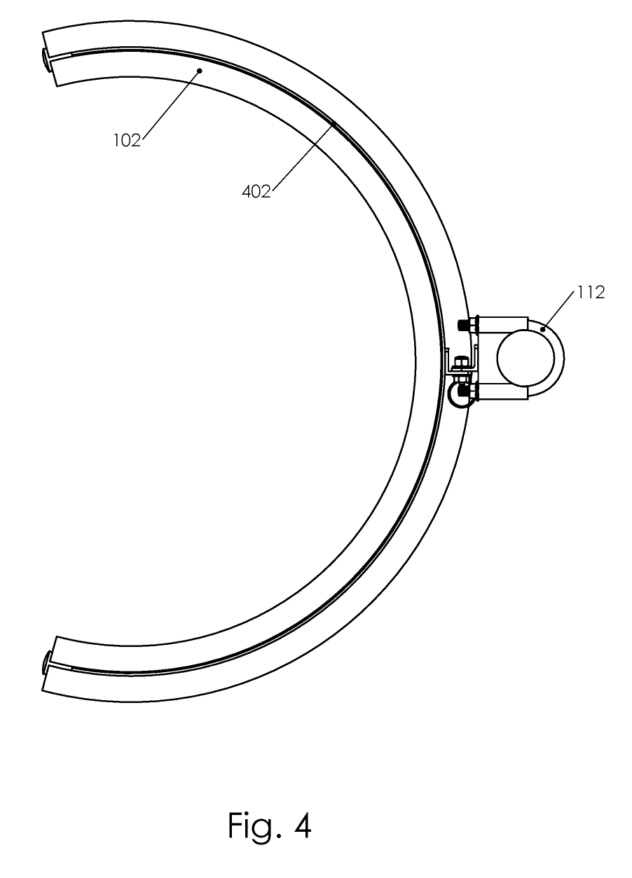

FIG. 4 is a diagram showing a bottom elevation view of the example vehicle mounted bag holder 100 with elastomeric pad 102 and a slit 402 along the length of the elastomeric pad.

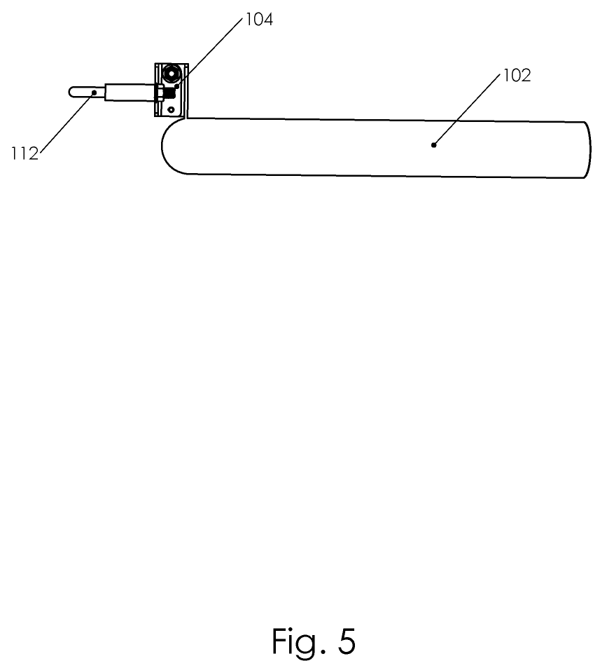

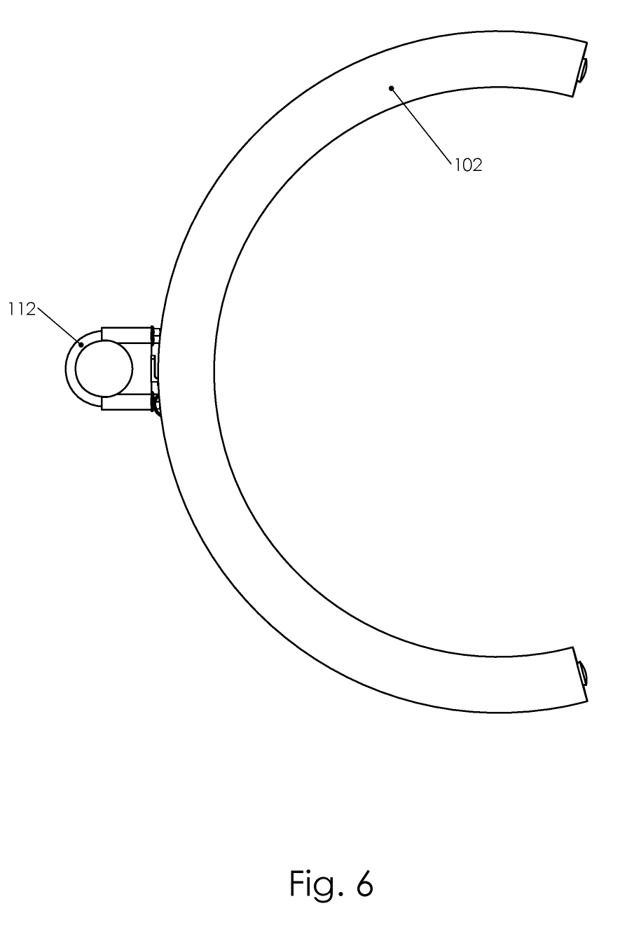

FIG. 5 shows a right elevation view of the example vehicle mounted bag holder 100 with elastomeric pad 102, the rotating bracket 104, and the mounting element 112. FIG. 6 shows a top elevation view of the vehicle mounted bag holder in which the elastomeric pad 102 and the mounting element 112 are shown.

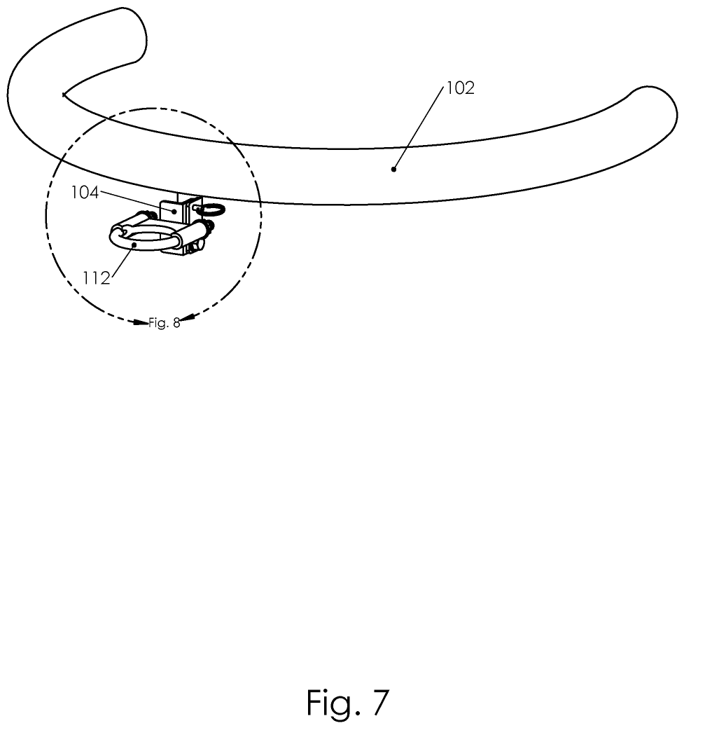

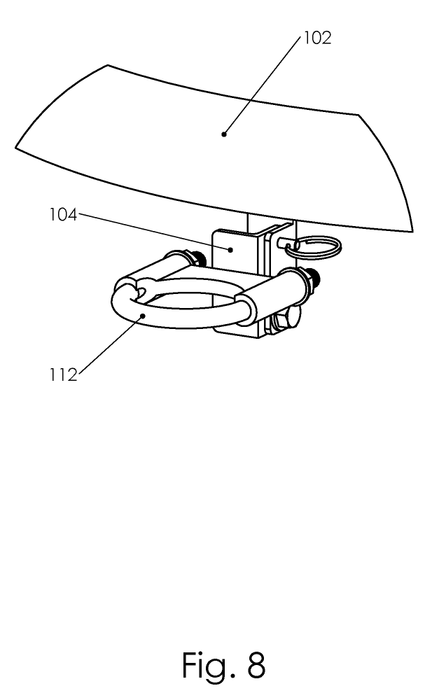

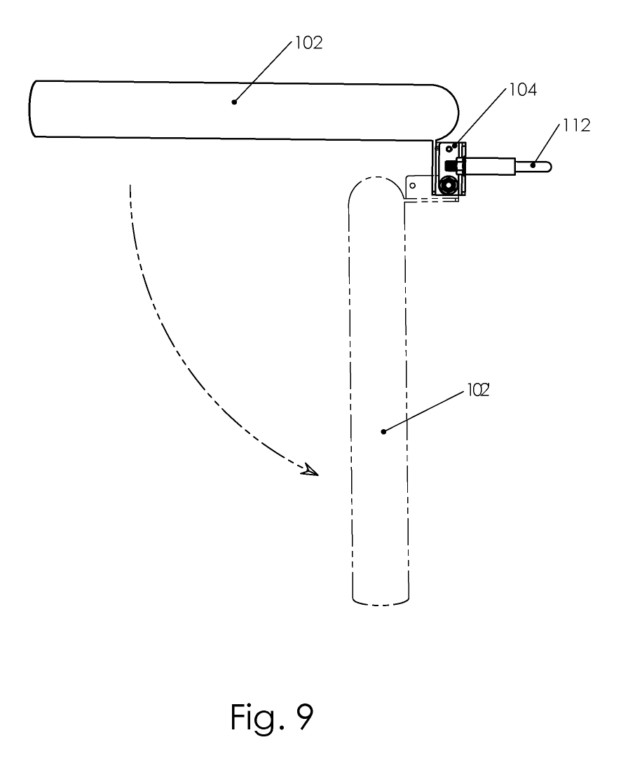

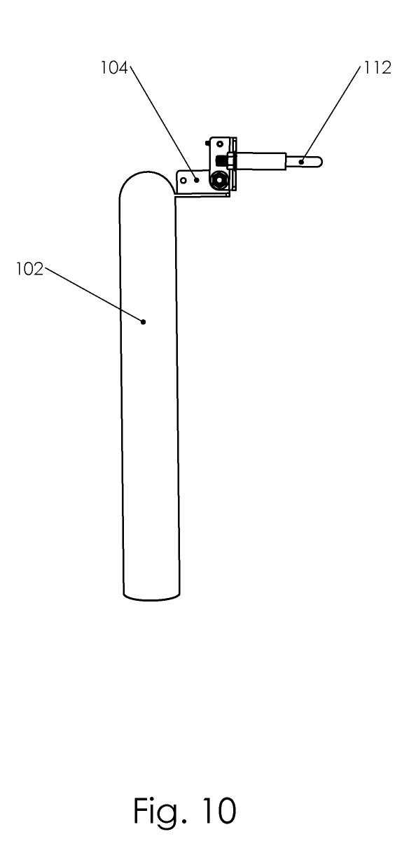

FIG. 7 is a diagram showing a rear elevation view of the vehicle mounted bag holder 100 in which the elastomeric pad 102, rotating bracket 104, and mounting element 112. Details of the rotating bracket 104 are shown in FIG. 8. The rotating bracket include a removable pin that can be inserted through holes in a first portion of the bracket attached to the mounting element and a second portion of the bracket attached to the frame member, where the holes are aligned when the frame portion is rotate up to an operational position (as shown in FIG. 8). When the pin is removed, the second portion of the bracket becomes free to rotate downwardly and lower the frame member to a stowed position (as shown by dashed lines in FIG. 9). The pin can be reinserted into a hole in the first bracket portion to secure the pin. The frame member covered by the protective member is shown in the stowed position in FIG. 10. Also, in FIG. 10, the hole in the first portion of the bracket and the hole in the second portion of the bracket are visible. The bracket can include an extension portion disposed between the mounting element and the first portion. The extension portion can extend in an upward direction from the mounting element to permit the frame member to be in an elevated position relative to the mounting element. Alternatively, the extension portion can extend in a downward direction from the mounting element to permit the frame member to be located below the mounting element.

The mounting element can be mounted to a frame of a vehicle, a front or rear bumper of the vehicle, a body panel of the vehicle, or the like. The vehicle can include, but is not limited to, a utility task vehicle (UTV), a recreational off-highway vehicle (ROV), a multipurpose off-highway utility vehicle (MOHUV), a truck or car, an all terrain vehicle (ATV), lawn or landscape maintenance equipment (mower, tractor, etc.), or the like. For example, the bag holder can be mounted to a truck bed by inserting bolts of the mounting element through the truck bed and securing the mounting element to the truck bed with nuts placed on the bolts. In another example, the bag holder can be mounted to a front of a lawn mower to permit an operator of the mower to place trash collected from a lawn (for example) into a bag held in place by the bag holder.

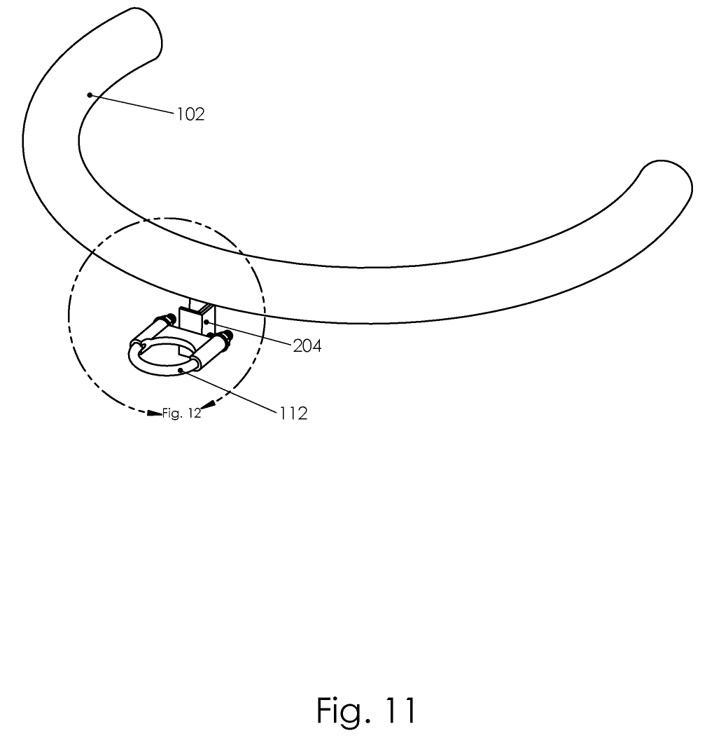

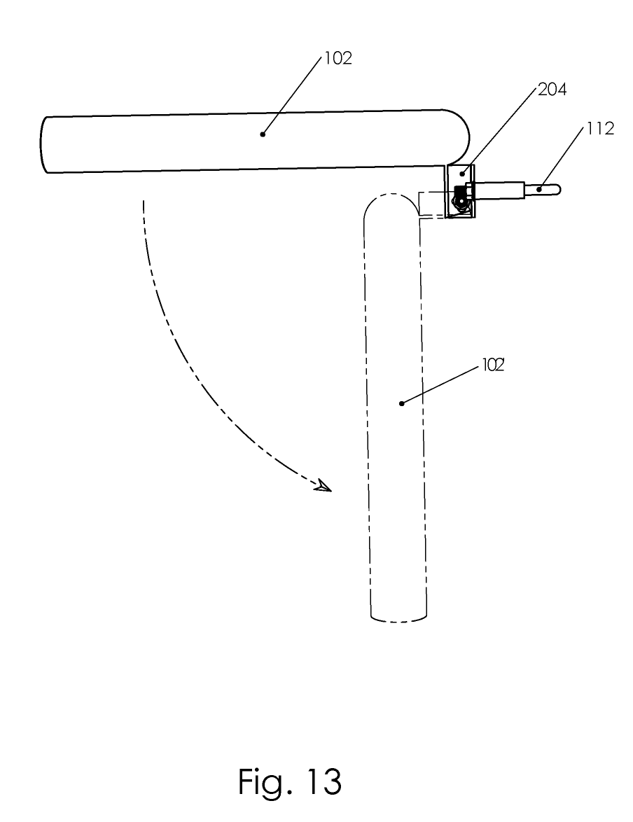

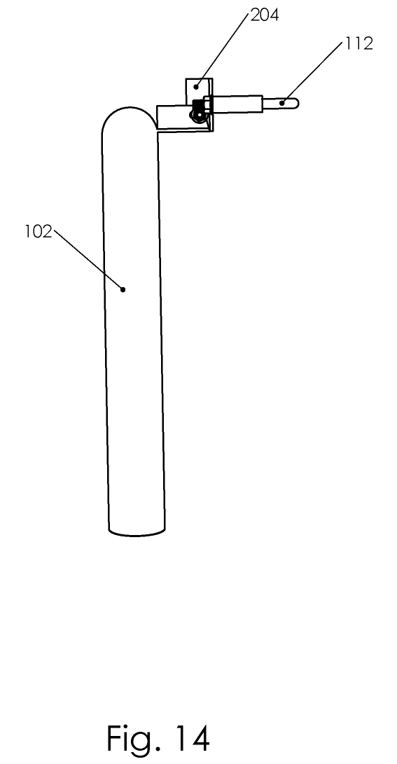

While FIGS. 7-10 show an example rotating bracket that includes a pin and corresponding holes in first and second portions of the bracket, other types of brackets can be used. For example, FIGS. 11-14 show a bracket 204 that includes a protrusion from a first portion of the bracket and a corresponding opening in a second portion of the bracket. The opening can be shaped so as to permit the protrusion to move into and out of the opening in a first position of the second portion (e.g., raised) and to prevent the protrusion from moving out of the opening when the first portion of the bracket is in a second position (e.g., lowered). Thus, when moving the frame member from the stowed position (e.g., lowered as shown in FIGS. 13 and 14) to the operational position (e.g. raised), the frame member and first bracket portion is lifted slightly to permit the protrusion on the second portion of the bracket to enter the opening on the first portion. Then, the frame member and first bracket portion are lowered slightly such that the protrusion is engage by a smaller opening in the first portion of the bracket and prevents the bracket from rotating to the stowed position.

When a user desires to place the frame member in the stowed position, the user simply lifts up slightly on the frame member and first bracket portion to permit the protrusion on the second bracket portion to be removed from the opening and thus permit the first bracket portion to rotate to a lowered (or stowed) position.

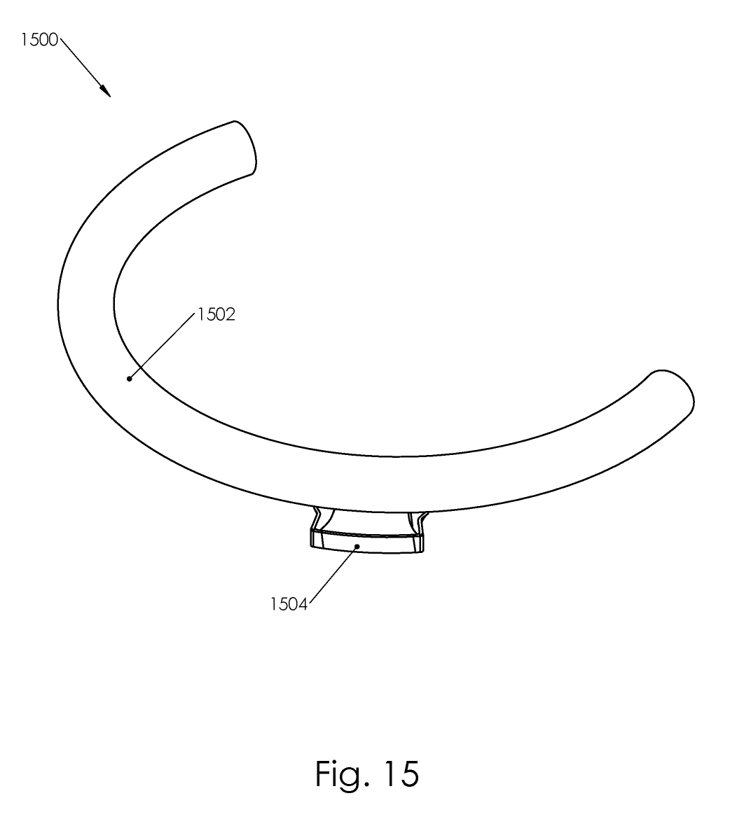

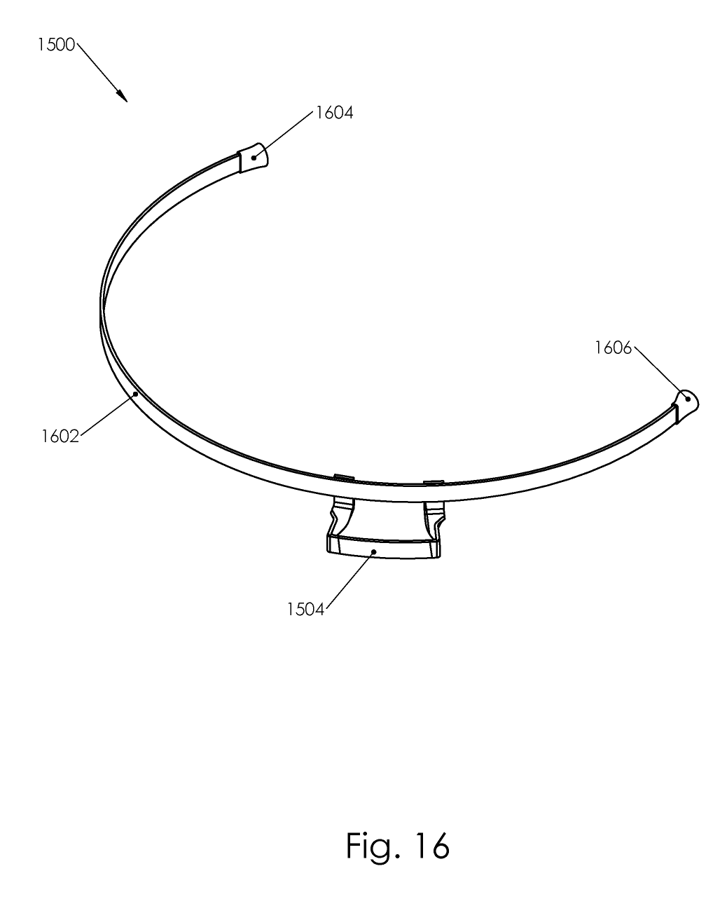

FIG. 15 is a diagram showing a left perspective view of an example handheld bag holder 1500 with elastomeric pad 1502 and handle member 1504. The handle 1504 can include a handle having an oval shape or a rectangular shape (as shown in FIGS. 15 and 16). In some implementations, the handle 1504 can be positioned at about 14 inches from an end of the bag holder.

FIG. 16 is a diagram showing a left perspective view of the handheld bag holder 1500 with elastomeric pad 1502 removed to reveal a frame member 1602, and elastomeric end caps 1604 and 1606. The frame member 1602 can be formed from steel, aluminum, injection molded plastic or other suitable material. The frame member 1602 can include a metal (e.g., aluminum) piece that is about ⅛″ thick, about ¾″ wide and about 36 to 42 inches long. The frame member 1602 can also provide spring tension to help hold a bag in place. For example, the frame member 1602 may have an end to end distance of about 27 inches, which, when taken in conjunction with the length of about 36-42 inches may provide a slightly larger opening than may be able to accommodate the bag without the frame member 106 being placed under some tension. The frame member 1602 may be placed under some external pressure (e.g., squeezed together slightly by force of the bag diameter) to effectively make the portion of a circle defined by the frame member smaller so as to accommodate the bag opening size. Then, once the bag is mounted on the frame member and protective element, the tension of the frame member 1602 in an outward expansion direction can act to help keep the bag in place on the bag holder.

It will be appreciated that any dimensions described herein are for illustration purposes only and are not intended to be limiting. Other dimensions could be used depending on a contemplated implementation.

It is, therefore, apparent that there is provided, in accordance with the various example implementations disclosed herein, handheld and vehicle mounted bag holder devices.

While the disclosed subject matter has been described in conjunction with a number of implementations, it is evident that many alternatives, modifications and variations would be or are apparent to those of ordinary skill in the applicable arts. Accordingly, Applicant intends to embrace all such alternatives, modifications, equivalents and variations that are within the spirit and scope of the disclosed subject matter.

1. A bag holder comprising:
a frame member having a first end and a second end and a curved surface that substantially conforms to a circle's curvature, or at least a portion or a segment of the circle's curvature;
a rotating bracket having a first portion and a second portion;
a mounting element configured to be attached to a vehicle frame; and
an elastomeric pad with an uneven surface disposed on the frame member,
wherein the frame member provides spring tension and the elastomeric pad provides friction to hold the bag in place without use of one or more fasteners,
wherein the first portion of the rotating bracket is attached to the mounting element and the second portion of the rotating bracket is attached to the frame member, and
wherein the rotating bracket is configured to be rotated between an operational position and a stowed position.

2. (canceled)

3. The bag holder of claim 1, wherein the elastomeric pad is formed from elastomeric foam.

4. The bag holder of claim 1, further comprising a first elastomeric end cap disposed on the first end and a second elastomeric end cap disposed on the second end.

5. The bag holder of claim 1, wherein the curved surface includes more than 180 degrees of the circle's curvature.

6. The bag holder of claim 1, wherein the mounting element is configured to be secured to a generally round vehicle frame element.

7. The bag holder of claim 1, wherein the mounting element is configured to be secured to a generally rectangular vehicle frame element.

8. A bag holder comprising:
a frame member having a first end and a second end and a curved surface that substantially conforms to a circle's curvature, or at least a portion or a segment of the circle's curvature;
a rotating bracket having a first portion and a second portion;
a mounting element configured to be attached to a vehicle frame; and
an elastomeric pad with an uneven surface disposed on the frame member,
wherein the elastomeric pad provides friction to hold the bag in place without use of one or more fasteners,
wherein the first portion of the rotating bracket is attached to the mounting element and the second portion of the rotating bracket is attached to the frame member, and
wherein the rotating bracket is configured to be rotated between an operational position and a stowed position.

9. (canceled)

10. The bag holder of claim 8, wherein the elastomeric pad is formed from elastomeric foam.

11. The bag holder of claim 8, further comprising a first elastomeric end cap disposed on the first end and a second elastomeric end cap disposed on the second end.

12. The bag holder of claim 8, wherein the curved surface includes more than 180 degrees of the circle's curvature.

13. The bag holder of claim 8, wherein the mounting element is configured to be secured to a generally round vehicle frame element.

14. The bag holder of claim 8, wherein the mounting element is configured to be secured to a generally rectangular vehicle frame element.

15. A bag holder comprising:
a frame member having a first end, a second end, and a curved surface that substantially conforms to a circle's curvature, or at least a portion or a segment of the circle's curvature; and a handle attached to the frame member, wherein the frame member provides spring tension to hold the bag in place without use of one or more fasteners.

16. The bag holder of claim 15, further comprising an elastomeric pad disposed on the frame member.

17. The bag holder of claim 16, wherein the elastomeric pad is formed from elastomeric foam.

18. The bag holder of claim 15, further comprising a first elastomeric end cap disposed on the first end and a second elastomeric end cap disposed on the second end.

19. The bag holder of claim 15, wherein the curved surface includes more than 180 degrees of the circle's curvature.

20. The bag holder of claim 15, wherein the handle includes a generally rectangular handle.

21. The bag holder of claim 8, wherein the frame member provides spring tension to hold the bag in place without use of one or more fasteners.

22. The bag holder of claim 16, wherein the elastomeric pad provides friction to hold the bag in place without use of one or more fasteners.
